(19) United States
(12) Patent Application Publication
(10) Pub. No.: US 2026/0237820 A1
(43) Pub. Date: Aug. 13, 2026

(54) BATTERY-POWERED GENERATOR SYSTEMS

(71) Applicant: Guojun Zhang, South Burlington, VT (US)

(72) Inventor: Guojun Zhang, South Burlington, VT (US)

(21) Appl. No.: 19/359,533

(22) Filed: Oct. 15, 2025

Related U.S. Application Data
(60) Provisional application No. 63/709,315, filed on Oct. 18, 2024.

(51) Int. Cl. H01M 50/244; B25H 3/02; B60L 53/302; B60L 53/31; B60L 53/51; H01M 50/249; H01M 50/271

(52) U.S. Cl. CPC H01M 50/244; B25H 3/02; B60L 53/302; B60L 53/31; B60L 53/51; H01M 50/249; H01M 50/271; B60L 2210/30; H01M 2220/20

(57) ABSTRACT

The present invention is a battery-powered generator system having a battery pack that is electrically coupled to an electrical system. The generator system provides charging ports and outlets for charging the system and powering equipment. It further comprises switches to operate the system. The system is placed within a housing with a lid, and optionally, a solar panel is coupled to the lid. The housing is fitted with an air-cooling duct to control temperature. The housing may further include a toolbox fitted with a drain hole located on the bottom of the toolbox, and a drainpipe coupled to the drain hole.

### CROSS REFERENCE TO RELATED APPLICATIONS

This application claims priority to the co-pending U.S. Provisional Application, Ser. No. 63/709,315, filed on Oct. 18, 2024, which is hereby incorporated by reference for all purposes.

### BACKGROUND

The present disclosure relates generally to generator systems. In particular, battery-powered generator systems are described.

It is well known to have generator systems. These items are typically used in remote areas for work, recreation, and the like, or in emergency situations when power is lost. A generator system typically includes fuel for its power source, such as gasoline, diesel, or natural gas.

Known generator systems are not entirely satisfactory for the range of applications in which they are employed. For example, existing fuel generator systems produce pollution from the fuel exhaust. In addition, conventional generator systems are noisy, causing disruption for recreational activities and interference with work activities.

Thus, there exists a need for generator systems that improve upon and advance the design of known generator systems. Examples of new and useful generator systems relevant to the needs existing in the field are discussed below.

### SUMMARY

The present invention is a battery-powered generator system having a battery pack that is electrically coupled to an electrical system. The generator system provides charging ports and outlets for charging the system and powering equipment. It further comprises switches to operate the system. The system is placed within a housing with a lid, and optionally, a solar panel is coupled to the lid. The housing is fitted with an air-cooling duct to control temperature. The housing may further include a toolbox fitted with a drain hole located on the bottom of the toolbox, and a drainpipe coupled to the drain hole.

### BRIEF DESCRIPTION OF THE DRAWINGS

FIG. 1 is a front view of an example of a generator system.

FIG. 2 is a side view of the generator system shown in FIG. 1, depicting an EV charging port.

FIG. 3 is a top view of the generator system shown in FIG. 1, depicting a water drain hole.

FIG. 4 is a front view of the generator system shown in FIG. 1, depicting a water drain pipe.

FIG. 5 is a front view of the generator system shown in FIG. 1, depicting a solar panel adapter.

FIG. 6 is a rear, internal view of the generator system shown in FIG. 1, depicting a car alternator adapter.

### DETAILED DESCRIPTION

The disclosed generator systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of generator system examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Contextual Details

Ancillary features relevant to the generator systems described herein will first be described to provide context and to aid in discussing the generator systems.

Vehicles

The generator systems disclosed herein are often used with vehicles, such as trucks, to provide mobility for the generator systems as well as a stable platform for ease and safety of use. Having the disclosed generator systems fixed to a vehicle also provides a convenient way to bring the generator systems to a recreation or work site.

### Battery-Powered Generator Systems

With reference to the figures, novel battery-powered generator systems will now be described. The novel generator systems discussed herein function to provide power in locations where accessing the power grid is unavailable or not desired.

The reader will appreciate from the figures and description below that the presently disclosed generator systems address many of the shortcomings of conventional fuel generator systems. For example, the novel generator systems provide reduced environmental and noise pollution.

### Generator System

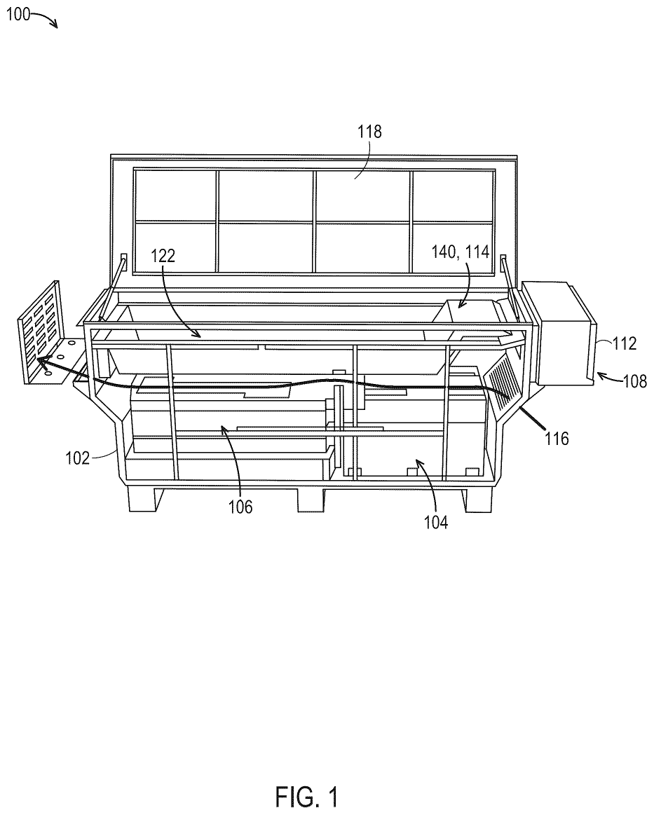

With reference to FIGS. 1-6, an example of a generator system, generator system 100, will now be described. Generator system 100 includes housing 102, battery pack 104, electrical system 106, charging ports 108, outlets 110, EV charging port 112, switches 114, air-cooling duct 116, solar panels 118, solar panel adapter 120, toolbox 122, water drain hole 124, water drain pipe 126, and vehicle alternator adapter 128.

In some examples, the generator system does not include one or more features included in the generator system 100. For example, some generator system examples do not include an EV charging port or solar panels with a solar panel adapter.

In other examples, the generator system includes additional or alternative features, such as a wireless charging pad for charging wireless devices.

### Housing

The housing 102 functions to house and protect the generator system 100. The housing 102 adopts a rain-proof design to provide a stable power supply outdoors. The house 102 also contains a heat-resistant design to provide stable, reliable power in high temperatures.

### Battery Pack

The battery pack 104 functions as the main power source for the generator system 100. The battery pack 104 comprises at least one lithium battery and an inverter. Lithium batteries are known for longevity and stability due to their stable chemistry. The battery pack 104 also provides a quieter and less polluting form of energy to power the generator system 100. One example of a lithium battery is the LifePo4 battery, which may last up to 20 years. As can be seen in FIG. 1, the battery pack 104 is located in front of the generator system 100 and is configured to be plug-and-play for easy installation, maintenance, and replacement if necessary.

### Electrical System

The electrical system 106 serves to house the electrical components needed to charge the battery pack 104, distribute power from the battery pack 104, and for the general functions of the generator. In the example shown in FIG. 1, the electrical system may include an inverter and electric vehicle (EV) charging piles. The inverter provides power output for the generator system 100. The inverter is also configured as plug-and-play for easy installation, maintenance, and replacement if necessary. In one example, the inverter provides an instantaneous output of 36 kW and continuous power of 10 kW. This provides an ideal power source for work site tools. The EV charging piles serve to charge the battery pack 104. In one example, the EV charging piles charge the battery pack 104 to provide a 10 kW power supply.

The electrical system 106 also houses the solar panel adapter 120, which is discussed in more detail below.

### Charging Ports

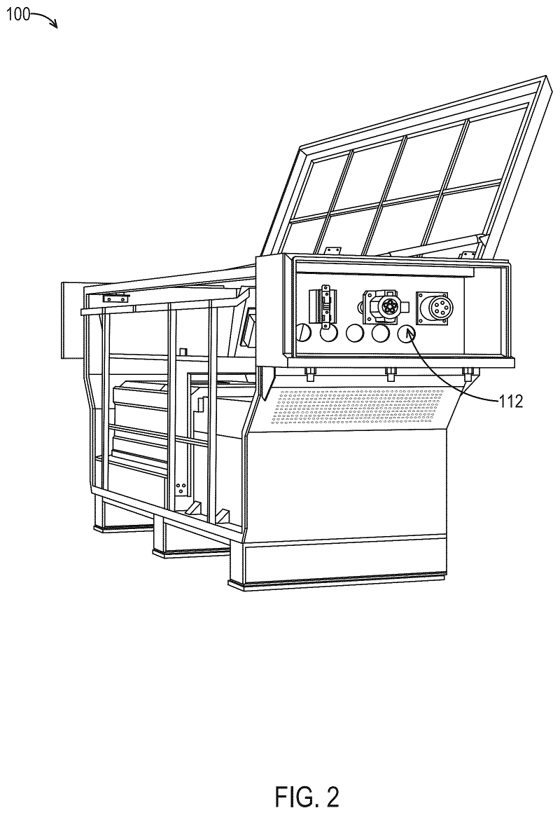

The charging ports 108 function to charge the battery pack 104. As can be seen in FIG. 1, the charging ports 108 are located on the side of the generator system 100. In other examples, the charging ports 108 may be located on other parts of the generator system 100. One example of a charging port 108 is an EV charging port 110, as shown in FIG. 2. Other types of charging ports may also be included in the generator system 100 to charge the battery pack 104.

### Outlets

The outlets 112 function to provide power to equipment, such as tools, light sources, and refrigeration units. The outlets 112 may be AC or DC. As can be seen in FIG. 1, the outlets 112 are located at the top of the generator system 100. In other examples, the outlets 112 may be located by the charging ports 108 on the side of the generator system 100 or other convenient locations on the generator system 100.

### Switches

The switches 114 function at least to start the generator system 100 and turn on/off the battery pack 104 charging sources. Other functions common to generators may also have a switch as its controller. As can be seen in FIG. 1, the switches 110 are located at the top of the generator system 100. In other examples, the switches 110 may be located by the charging ports 108 on the side of the generator system 100, as shown in FIG. 2, or other convenient locations on the generator system 100.

### Air-Cooling Duct

The air-cooling duct 116 functions to aid in transferring the heat generated by the generator system 100. As can be seen in FIG. 1, the air-cooling duct 116 is located along the front of the generator system 100. In other example, the air-cooling duct 116 may be located on other parts of the generator system 100.

### Solar Panels

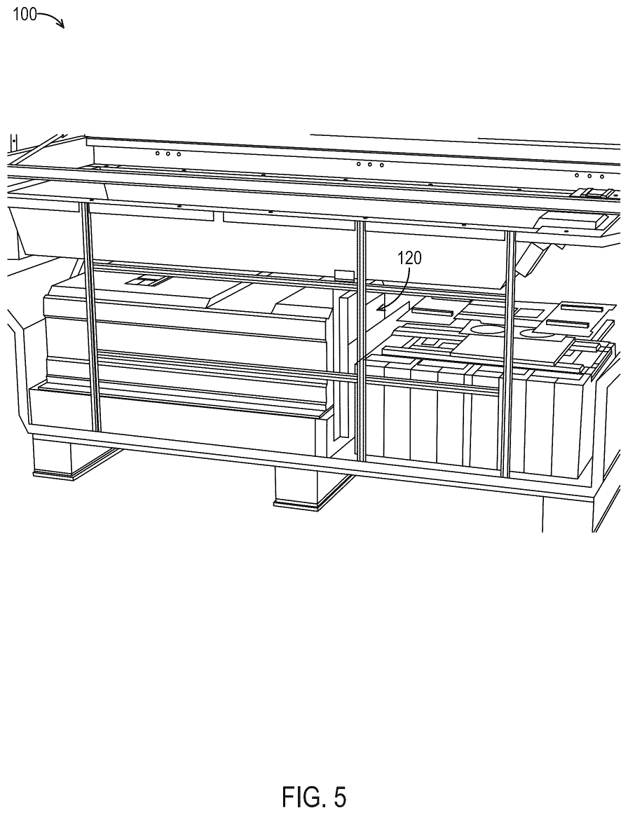

The solar panels 118 serve as another source to charge the battery pack 104. As can be seen in FIG. 1, the solar panels 118 are located on the inside of the lid of the housing 102. In other examples, the solar panels 118 may be located on the outside of the lid of the housing 102. In another example, the solar panels 118 may be portable as to be placed near the generator system 100 to take advantage of the best source of sunlight. The solar panels 108 may then be stored in the housing 102, such as the inside of the lid. As can be seen in FIG. 5, the solar panel adapter 120 allows for direct connection to the solar panels via a dedicated port within to facilitate eco-friendly and efficient charging of the battery pack 104.

### Toolbox

The toolbox 122 functions to hold the equipment using the generating system 100. As can be seen in FIG. 1, the toolbox 122 provides ample space to hold equipment. The toolbox 120 may also be used as storage.

### Water Drain Hole

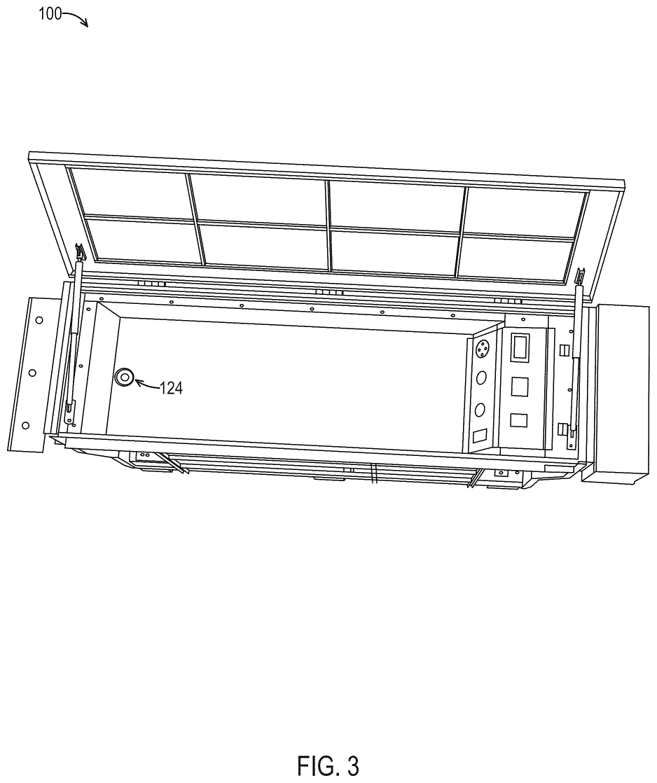

The water drain hole 124 functions to funnel any water into the water drain pipe 126 that may infiltrate the toolbox 122. As can be seen in FIG. 3, the water drain hole 124 is located at the bottom of the toolbox 122.

### Water Drain Pipe

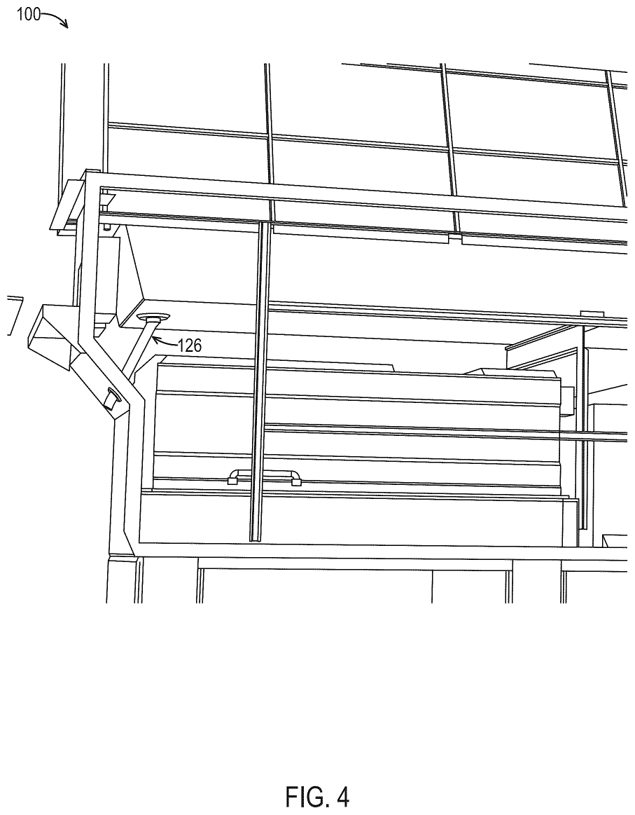

The water drain pipe 126 functions to protect the electrical components of the generator system 100. As can be seen in FIG. 4, the water drain pipe 126 guides the water away from the electrical components in the generator system 100. The configuration of the water drain pipe 126 may be in any suitable arrangement for the purpose of draining water out of the toolbox 122.

### Vehicle Alternator Adapter

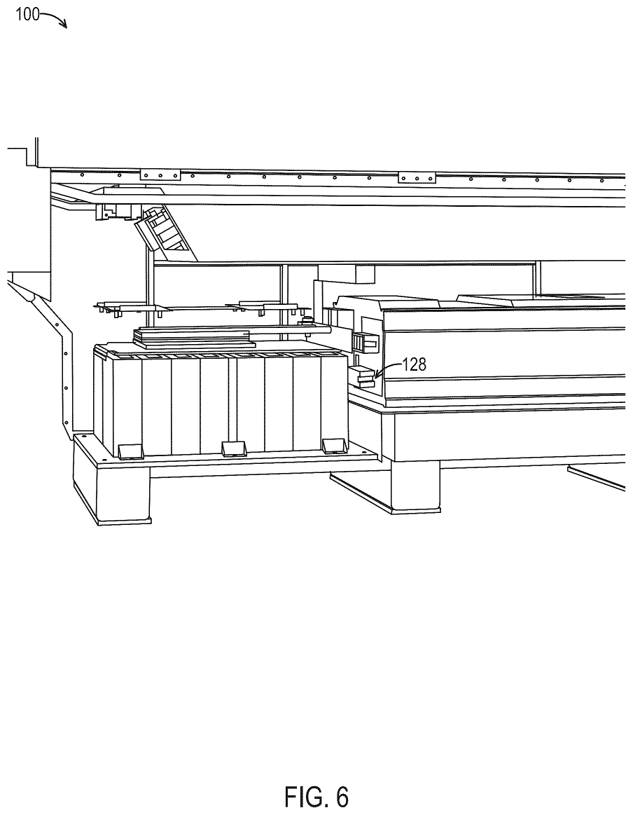

The vehicle alternator adapter 128 functions to monitor and maintain the health of the vehicle's start battery. When the vehicle's start battery dips below a certain value, the electrical system 106 and battery pack 104 initiate a reverse charging process to keep the vehicle's start battery in optimum condition. In another example, the vehicle alternator adapter 128 can also function to charge the battery pack 104. As can be seen in FIG. 6, the vehicle alternator adapter 128 is located within the electrical system 106.

Applicant(s) reserves the right to submit claims directed to combinations and subcombinations of the disclosed inventions that are believed to be novel and non-obvious. Inventions embodied in other combinations and subcombinations of features, functions, elements, and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A battery-powered generator system comprising:
a. a vehicle, a housing, and a generator system, where the generator system is located within the housing, and the housing is coupled to the vehicle.

2. Where the generator system of claim 1 further comprises:
a. a battery pack, an electrical system, an inverter, charging ports, outlets, and switches; where the battery pack is located in front of the generator system, the electrical system is located within the housing; the charging ports are located on the side of the generator system, the outlets are located on the top of the generator system, and the switches are located on the top of the generator system or on at least one side of the generator system; and
b. the battery pack, charging ports, outlets, inverter, and switches are electrically coupled to the electrical system.

3. Where the generator system of claim 2 further comprises:
a. a lid coupled to the housing, at least one solar panel coupled to the lid, an air-cooling duct, located within the generator system, or located along the front of the generator system, and the electrical system further includes a vehicle alternator adapter.

4. Where the generator system of claim 3 further comprises:
a. a toolbox located within the housing, a drain hole located on the bottom of the toolbox, and a drainpipe coupled to the drain hole.

5. A battery-powered generator system comprising:
a. a vehicle, a housing, and a generator system, where the generator system is located within the housing, and the housing is coupled to the vehicle; and
b. Where the generator system further comprises:
i. a battery pack, an electrical system, an inverter, charging ports, outlets, and switches; where the battery pack is located in front of the generator system, the electrical system is located within the housing; the charging ports are located on the side of the generator system, the outlets are located on the top of the generator system, and the switches are located on the top of the generator system or on at least one side of the generator system; and
ii. the battery pack, charging ports, outlets, inverter, and switches are electrically coupled to the electrical system; and
iii. a lid coupled to the housing, at least one solar panel coupled to the lid, an air-cooling duct, located within the generator system, or located along the front of the generator system, and the electrical system further includes a vehicle alternator adapter.

6. Where the generator system of claim 5 further comprises:
a. a toolbox located within the housing, a drain hole located on the bottom of the toolbox, and a drainpipe coupled to the drain hole.
